(19) United States
(12) Patent Application Publication
(10) Pub. No.: US 2008/0286649 A1
(43) Pub. Date: Nov. 20, 2008

(54) ADDITIVES FOR INCREASING ION CONDUCTIVITY OF MOLTEN SALT TYPE ELECTROLYTE IN BATTERY

(75) Inventors: Wen Li, Ypsilanti, MI (US); Yutaka Oyama, Aichi (JP)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Motor Engineering & Manufacturing North America, Inc., Erlanger, KY (US)

(21) Appl. No.: 12/031,502

(22) Filed: Feb. 14, 2008

Related U.S. Application Data
(62) Division of application No. 11/130,299, filed on May 16, 2005, now abandoned.
(60) Provisional application No. 60/571,778, filed on May 17, 2004.

(51) Int. Cl. H01M 6/04

(52) U.S. Cl. 429/188

(57) ABSTRACT

A lithium-ion battery comprises a negative electrode, a positive electrode, and an electrolyte containing a molten salt, a lithium salt, and an electrolyte additive. The electrolyte additive is chosen to increase the lithium ion conductivity of electrolyte. The electrolyte additive may be an organic, additive, such as an organic carbonate. In other examples, the electrolyte additive provides a source of alkali metal cations other than lithium, such as potassium, sodium, and/or cesium ions. An analogous approach can be taken for batteries using ionic species other than lithium.

### REFERENCE TO RELATED APPLICATION

This application claims priority of U.S. Provisional Patent Application Ser. No. 60/571,778, filed May 17, 2004, the entire content of which is incorporated herein by reference.

### FIELD OF THE INVENTION

The present invention relates to batteries, in particular to rechargeable batteries having a molten salt electrolyte.

### BACKGROUND OF THE INVENTION

Molten salt electrolytes have good safety and performance at high temperature, compared with conventional organic electrolytes, because of their high melting point and low vapor pressure. A molten salt electrolyte is an electrolyte comprising one or more salts, that is at least partially molten (or liquid) at the operating temperatures of the device using the electrolyte. A molten salt electrolyte may also be described as a molten, non-aqueous electrolyte, as an aqueous solvent is not required. However, at room temperature or lower, lithium ion (Li⁺) conductivity is typically lower than that of an organic electrolyte. Viscosity greatly affects the ion conductivity of the electrolyte, which is one of the key parameters for battery performance. Hence, there is a need for lithium-ion batteries having the enhanced safety of molten salt electrolyte batteries, but having improved lithium ion conductivities compared with those provided by conventional molten salt electrolytes.

### SUMMARY OF THE INVENTION

A battery comprises a negative electrode, a positive electrode, and an electrolyte including a molten salt, a cation source, and an electrolyte additive. The electrolyte additive can be one or more organic compounds chosen to increase the cation conductivity of the electrolyte.

The cation can be an alkali metal ion, such as lithium ion, corresponding to a molten salt lithium ion battery. Example electrolyte additives include organic compounds, such as an organic carbonate, for example an alkyl or dialkyl carbonate, organic phosphate. The additive may be any organic aprotic compound, such as a polar aprotic compound. Additives may also include compounds including a heterocycle, such as an N, O, and/or S containing heterocycle.

An improved lithium-ion battery includes a negative electrode, a positive electrode, and an electrolyte containing a molten salt, a lithium salt, and an electrolyte additive, the electrolyte additive being chosen to increase the lithium ion conductivity of the electrolyte. The electrolyte additive may be an organic additive. In other examples, the electrolyte additive provides a source of alkali metal cations other than lithium, such as potassium, sodium, and/or cesium ions, These non-lithium cations, in addition to an organic additive or separately, also enhance the lithium ion conductivity of the electrolyte. Hence, the electrolyte additive can be a salt of potassium, sodium, or cesium.

The organic additive may be selected from a group consisting of carbonates, phosphates, epoxides, ethers, acetates, formates, dioxolanes, esters, alcohols, amines, alkyl halides, alkanes, alkenes, nitriles, imines, nitro compounds, aldehydes, ketones, and aromatic compounds.

In examples of the present invention, the electrolyte additive comprises an organic carbonate, present in a mole percentage relative to the molten salt that is insufficient for electrolyte flammability under normal battery operating conditions, but otherwise high enough to appreciably increase the ion conductivity of the electrolyte.

### BRIEF DESCRIPTION OF THE FIGURES

FIG. 1 shows discharge rate capacities of two example batteries according to the present invention, compared with a reference battery; and

FIG. 2 shows a schematic of a battery.

### DETAILED DESCRIPTION OF THE INVENTION

An organic additive can be added to a molten salt electrolyte so as to modify the viscosity and increase the ion conductivity of the molten salt electrolyte. Hence, the organic additive can improve the performance of molten salt type Li-ion battery. An organic additive can greatly improve viscosity and Li⁺ conductivity of a molten salt electrolyte, especially at room temperature or lower temperatures. The organic additive may include a single organic compound, or may include a mixture of two or more organic compounds. The organic additive may include one or more compounds such as an alkyl carbonate, epoxide, ether, alcohol, amine, all halide, arcane, alkene, nitrite, imine, or a nitro compound. Other examples of organic compounds which can be used include acetates, esters, aldehydes, ketones, and aromatic compounds.

Organic additives are described which can decrease the viscosity and increase the Li⁺ conductivity of a molten salt electrolyte in a lithium-ion battery. Examples of organic compounds which can be used as additives to improve the properties of a molten salt electrolyte include organic carbonates and organic phosphates. Example organic carbonates include alkyl carbonates (such as dialkyl carbonates), alkenyl carbonates, cyclic and non-cyclic carbonates, fluorinated organic carbonates (such as fluoroalkyl carbonates), other halogenated organic carbonates, and the like. For example, the organic additive may include one or more of the following compounds: ethylene carbonate, propylene carbonate, butylene carbonate, ethyl methyl carbonate (EMC), diethyl carbonate (DEC), dimethyl carbonate (DMC), dipropyl carbonate (DPC), dibutyl carbonate (DBC), ethyl carbonate (EC), methyl propyl carbonate (MPC), ethyl propyl carbonate (EPC), and the like. Alkyl carbonates also include fluorinated alkyl carbonates and other alkyl carbonate derivatives.

Organic phosphates include compounds having the general formula (R₁O) P(═O) (OR₂) (OR₃), where R₁, R₂ and R₃ may be hydrogen or an organic substituent such as an alkyl, aromatic, or unsaturated group. Here, R₁, R₂, and R₃ may be the same or different. Examples include alkyl phosphates, dialkyl phosphates, and trialkylphosphates such as TMP (trimethyl phosphate).

Other organic compounds, such as those used as organic solvents in conventional organic solvent lithium-ion batteries, can also be used as additives to a molten salt electrolyte. Examples include polar aprotic compounds.

The organic additive may include an epoxide, ether, acetate (such as alkyl acetate), formate (such as an alkyl formate), dioxolane (such as an alkyl dioxolane), diester (such as an oxalate), alcohol, amine, alkyl halide, alkane, alkene, nitrile, imine, or a nitro compound. Other examples of organic additives which can be used include acetates, esters, aldehydes, thiophenes, ketones, and aromatic compounds.

For example, the organic additive may include one or more of the following compounds: dimethyl ether, gamma-butyrolactone, 1,2-dimethoxyethane, tetrahydrofuran, 2-methyltetrahydrofuran, 1,3-dioxolane, sulfolane, 4-methyl-1,3-dioxolane, methyl formate, methyl acetate, dimethylsulfoxide, methyl propionate, triglyme, tetraglyme, and the like.

In a lithium-ion battery, the electrolyte contains a source of lithium ions, such as one or more lithium salts selected from the following group: LiPF₆, LiAsF₆, LiSbF₆, LiBF₄, LiClO₄, LiCF₃SO₃, Li(CF₃SO₂) ₂N, Li(C₂F₅SO₂) ₂N, LiC₄F₉SO₃, Li(CF₃SO₂) ₃C, LiBPh₄, LIBOB, and Li(CF₃SO₂)(CF₃CO)N.

Organic additives can also be used to improve the properties of molten-salt containing electrolytes used in other battery technologies, such as those based on other ionic species, such as different alkali ions in an alkali-ion battery, such as a Na⁺ or K₊ rechargeable battery. Additives may also be used in applications other than batteries where ion conductivity of a molten-salt containing medium is important.

An example lithium-ion (Li-ion) battery comprises a lithium metal oxide cathode (such as LiCoO₂ or LiNiO₂), a carbon-based anode (such as graphite), and an electrolyte comprising a molten salt and an organic additive, and further comprising a cation source. The cation source can be a lithium salt dissolved in the electrolyte. The organic additive may be an organic solvent such as used in organic electrolyte lithium-ion batteries to dissolve a lithium salt, however in this example the electrolyte includes a molten salt. The terms anode and cathode here refer to the negative and positive electrodes of the battery, respectively. The anode, such as a graphite anode, intercalates or otherwise stores lithium ions, which are released during discharge, and at the same time lithium ions are inserted into the cathode electroactive material. Conventional organic electrolytes which may be used as organic additives in a molten salt electrolyte are discussed in U.S. Pat. No. 6,492,064 to Smart et al.

Batteries according to examples of the present invention have a molten salt electrolyte. The term molten salt electrolyte is used herein to represent an electrolyte including one or more molten salts as a significant component of the electrolyte, for example more than 30 percent of the electrolyte. A molten salt electrolyte is an electrolyte comprising one or more salts, that is at least in part molten (or otherwise liquid) at the operating temperatures of the battery. A molten salt electrolyte can also be described as a molten, non-aqueous electrolyte, as an aqueous solvent is not required, or as an ionic liquid.

In a lithium-ion battery and similar rechargeable batteries, the term anode is conventionally used for the negative electrode, and the term cathode is conventionally used for the positive electrode. These designations are technically correct only for the battery in a discharge cycle, however these designations are widely used in the literature and are used herein, The term battery is used herein to refer to a device including one or more electrochemical cells.

Molten salt electrolytes which may be used in embodiments of the invention are described in U.S. Pat. Nos. 4,463,071 to Gifford; 5,552,241 to Mamantov et al.; 5,589,291 to Carlin et al.; 6,326,104 to Caja et al.; 6,365,301 to Michot; and 6,544,691 to Guidotti, European Patent EP-0918364 describes phosphate additives for traditional organic electrolyte in alkali metal electrochemical cells, but not for use as additives in molten salt electrolytes, however these disclosed phosphate additives can be used as organic additives in examples of the present invention.

Example molten salts include those having an aromatic cation (such as an imidazolium salt or a pyridinium salt), an aliphatic quaternary ammonium salt, or a sulfonium salt. The molten salt electrolyte in the invention may include an onium, such as an ammonium, a phosphonium, an oxonium, a sulfonium, an amidinium, an imidazolium, a pyrazolium, and an anion, such as PF₆⁻, BF₄⁻, CF₃SO₃⁻, (CF₃SO₂)₂N⁻, (FSO₂)₂N⁻, (C₂F₅SO₂)₂N⁻, Cl⁻ and Br⁻.

A molten salt electrolyte used in an example of the present invention may also include Y⁺N⁻(—SO₂Rf²)(—XRf³), where Y⁺ is a cation selected from the group consisting of an imidazolium ion, an ammonium ion, a sulfonium ion, a pyridinium, a(n) (iso)thiazolyl ion, and a(n) (iso) oxazolium ion, which may be optionally substituted with C₁₋₁₀ alkyl or C₁₋₁₀ alkyl having ether linkage, provided that said cation has at least one substituent of —CH₂Rf¹ or —OCH₂Rf¹ (where R^{f1} is C₁₋₁₀ polyfluoroalkyl); Rf² and Rf³ are independently C₁₋₁₀ perfluorophenyl or may together from C₁₋₁₀ perfluoroalkylene; and X is —SO₂— or —CO—.

Molten salts include salts having an aromatic cation (such as an imidazolium salt or a pyridinium salt), aliphatic quaternary ammonium salts, and sulfonium salts.

Imidazolium salts include salts having a dialkylimidazolium ion, such as a dimethylimidazolium ion, an ethylmethylimidazolium ion, a propylmethylimidazolium ion, a butylmethylimidazolium ion, a hexylmethylimidazolium ion or an octylmethylimidazolium ion, or a trialkylimidazolium ion such as a 1,2,3-trimethylimidazolium ion, a 1-ethyl-2,3-dimethylimidazolium ion, a 1-butyl-2,3-dimethylimidazolium ion or a 1-hexyl-2,3-dimethylimidazolium ion. Imidazolium salts include ethylmethylimidazolium tetrafluoroborate (EMI-BF₄), ethylmethylimidazolium trifluoromethanesulfonylimide (EMI-TFSI), propylmethylimidazolium tetrafluoroborate, 1,2-diethyl-3-methylimidazolium trifuoromethanesulfonylimide (DEMI-TFSI), and 1,2,4-triethyl-3-methylimidazolium trifluoromethanesulfonylimide (TEMI-TFSI).

Pyridinium salts include salts having an alkyl pyridinium ion, such as a 1-ethylpyridinium ion, a 1-butylpyridinium ion or a 1-hexylpyridinium ion. Pyridinium salts include 1-ethylpyridinium tetrafluoroborate and 1-ethylpyridinium trifluoromethanesulfonylimide.

Ammonium salts include trimethylpropylammonium trifluoromethanesulfonylimide (TMPA-TFSI), diethylmethylpropylammonium trifluoromethanesulfonylimide, and 1-butyl-1-methylpyrrolidinium trifluoromethanesulfonylimide. Sulfonium salts include triethylsulfonium trifluoromethanesulfonylimide (TES-TFSI).

In a secondary battery operating through the migration of cations, the electrolyte typically contains a cation source, providing cations according to the type of battery. In the case of a lithium-ion battery, the cation source can be a lithium salt. Lithium salts in the electrolyte of a lithium-ion battery may include one or more of the following: LIPF₆, LiAsF₆, LiSbF₆, LiBF₄, LiClO₄, LiCF₃SO₃, Li(CF₃SO₂)₂N, Li(C₂F₅SO₂)₂N, LiC₄F₉SO₃, Li(CF₃SO₂)₃C, LiBPh₄, LiBOB, and Li(CF₃SO₂)(CF₃CO)N. Examples of the present invention can include rechargeable batteries using ions other than lithium, such as other alkali metal or other cation based batteries, in which case an appropriate salt is used. For example, the molten salt of a potassium-ion battery may include KPF₆ or other potassium-ion providing compound.

Other than the organic additives discussed above, a source of alkali ions, such as Na⁺, K⁺, Cs⁺, may also be used as additives to increase Li⁺ conductivity in a molten salt electrolyte based Li-ion battery.

In other examples of the present invention, the properties of a battery based on transport of a particular cation are enhanced through inclusion of other cationic species. In the case of a lithium-ion battery, sources of other alkali metal ions can be included. For example, the electrolyte of a lithium-ion battery typically include a lithium salt as a source of lithium ions, and an electrolyte additive to enhance the lithium ion conductivity may comprise a potassium salt, a sodium salt, and/or a cesium salt.

The electrolyte of a battery according to the present invention may further include a salt of another cation other than the transported cation, which can increase the ion conductivity of the electrolyte. For example, the electrolyte of a lithium-ion battery may include one or more salts such as: NaPF₆, NaAsF₆, NaSbF₆, NaBF₄, NaClO₄, NaCF₃SO₃, Na(CF₃SO₂) ₂N, Na(C₂F₅SO₂) ₃C, NaBPh₄F₉SO₃, Na(CF₃SO₂) ₃C, NaBPh₄, NaBOB, Na(CF₃SO₂)(CF₃CO)N, and/or potassium or cesium analogs of these salts. For example, the properties of the electrolyte of a lithium-ion battery can be improved by including a source of non-lithium alkali metal ions, such as a sodium salt such as those listed above, or a potassium analog KPF₆ or another potassium salt).

The organic additive may be a material which may be used as an organic solvent in a conventional organic electrolyte. For example, organic additives to a molten salt electrolyte may include an alkyl carbonate (including dialkyl carbonates), alkenyl carbonates, and other organic additives. Organic additives may include one or more of the following: ethylene carbonate, propylene carbonate, butylene carbonate, gamma-butyrolactone, 1,2-dimethoxyethane, tetrahydrofuran, 2-methyltetrahydorofuran, 1,3-dioxolane, 4-methyl-1,3-dioxolane, methyl formate, methyl acetate, methyl propionate, dimethyl carbonate, ethyl methyl carbonate, and diethyl carbonate.

Improved electrolytes according to examples of the present invention may be used with various battery technologies, including lithium-ion batteries, other alkali metal ion batteries, and batteries using transport of other metal ions, or organic ions.

In an example battery, the negative electrode (anode) includes a negative electrode active material and an electron conductive material, and the positive electrode (cathode) includes a positive electrode active material and an electron conductive material. Both the negative electrode and the positive electrode may be formed on an electron collector. Electrodes may further include a binder.

The electroactive material of the cathode (positive electrode) may be a material allowing cation insertion and release. In the case of a lithium-ion battery, the cathode electroactive material can be a lithium composite oxide, such as a lithium metal oxide (an oxide of lithium and at least one other metal species). Example lithium composite oxides include Li-Ni-containing oxides (such as LiₓNiO₂), Liₓ(Ni,Co)O₂), Li-Mn-containing oxides (such as LiₓMnO₂, LiₓMn₂O₄, LiₓNi_{0.5}Mn_{1.5}O₄, and other lithium manganese nickel oxides), and Li-Co-containing oxides (such as LiₓCoO₃), other lithium transition metal oxides, lithium metal phosphates (such as (such as LiCoPO₄ and fluorinated lithium metal phosphates such as Li₂CoPO₄F), and other lithium metal chalcogenides, where the metal can be a transition metal. Lithium composite oxides include oxides of lithium and one or more transition metals, and oxides of lithium and one or more metals selected from the group consisting of Co, Al, Mn, Cr, Fe, V, Mg, Ti, Zr, Nb, Mo, W, Cu, Zn, Ga, Int Sn, La and Ce. The cathode electroactive material may be nanostructured, for example in the form of nanoparticles having a mean diameter less than one micron.

The anode (negative electrode) can comprise an anode electroactive material, and (optionally) an electron conductive material and a binder. The anode may be formed in electrical communication with an anode electron collector.

The anode electroactive material may be carbon based, such as graphitic carbon and/or amorphous carbon, such as natural graphite, mesocarbon microbeads (MCMBs), highly ordered pyrolytic graphite (HOPG), hard carbon or soft carbon, or a material comprising silicon and/or tin, or other components. The negative electrode may be a lithium titanate, such as Li₄Ti₅O₁₂.

Rechargeable batteries according to examples of the present invention include those based on any cation that can be reversibly stored (for example, inserted or intercalated) and released. Cations may include positive ions of alkali metals such as lithium, sodium, potassium, and cesium; alkaline earth metals such as calcium and barium; other metals such as magnesium, aluminum, silver and zinc; and hydrogen. In other examples, cations may be ammonium ions, imidazolium ions, pyridinium ions, phosphonium ions, sulfonium ions, and derivatives thereof, such as alkyl or other derivatives of such ions.

Electron conductive materials which may be used in anodes or cathodes of batteries according to examples of the present invention may comprise a carbon-containing material, such as graphite. Other example electron-conductive materials include polyaniline or other conducting polymer, carbon fibers, carbon black (or similar materials such as acetylene black, or Ketjen black), and non-electroactive metals such as cobalt, copper, nickel, other metal, or metal compound. The electron conducting material may be in the form of particles (as used here, the term includes granules, flakes, powders and the like), fibers, a mesh, sheet, or other two or three-dimensional framework. Electron conductive materials also include oxides such as SnO₂ , Ti₄O₇, In₂O₃/SnO₂ (ITO), Ta₂O₅, WO₂, W₁₈O₄₉, CrO₂ and Tl₂O₃, carbides represented by the formula MC (where M is a metal, such as WC, TiC and TaC), carbides represented by the formula M₂C, metal nitrides, and metallic tungsten

An example battery may further include electrical leads and appropriate packaging, for example a sealed container providing electrical contacts in electrical communication with the first and second current collectors.

An electron collector may be electrically conductive member comprising a metal, conducting polymer, or other conducting material. The electron collector may be in the form of a sheet, mesh, rod, or other desired form. For example, an electron collector may comprise a metal such as Al, Ni, Fe, Ti, stainless steel, or other metal or alloy. The electron collector may have a protective coating to reduce corrosion, for example a protection layer comprising tungsten (W), platinum (Pt), titanium carbide (TiC), tantalum carbide (TaC), titanium oxide (for example, Ti₄O₇), copper phosphide (Cu₂P₃), nickel phosphide (Ni₂P₃), iron phosphide (FeP), and the like.

One or both electrodes may further include a binder. The binder may comprise one or more inert materials, for the purpose of improving the mechanical properties of the electrode, facilitating electrode manufacture or processing, or other purpose. Example binder materials include polymers, such as polyethylene, polyolefins and derivatives thereof, polyethylene oxide, acrylic polymers (including polymethacrylates), synthetic rubber, and the like. Binders may also include fluoropolymers such as polyvinylidene fluoride (PVdF), polytetrafluoroethylene (PTFE), poly(vinylidene fluoride-hexaeuoropropylene) copolymers (PVDF-HFP), and the like.

A battery may further comprise a housing, electrode connections and terminals, and a separator between the cathode and the anode. Batteries may include one or more separators, located between the negative electrode and positive electrode for the purpose of preventing direct electrical contact (a short circuit) between the electrodes. A separator can be an ion-transmitting sheet, for example a porous sheet, film, mesh, or woven or non-woven cloth, fibrous mat (cloth), or other form. The separator is optional, and a solid electrolyte may provide a similar function. A separator may be a porous or otherwise ion-transmitting sheet, including a material such as a polymer (such as polyethylene, polypropylene, polyethylene terephthalate, methyl cellulose, or other polymer), sol-gel material, ormosil, glass, ceramic, glass-ceramic, or other material. A separator may be attached to a surface of one or both electrodes.

### EXAMPLES

Ion conductivity measurements were by an AC impedance method at room temperature. An example battery (Example 1) was constructed as a laminate cell having, a cathode comprising cathode electroactive material LiCoO₂, acetylene black as the electron conductive material, and PVdF as the binder. The cathode current collector was aluminum foil. The anode comprised anode active material Li₄Ti₅O₁₂, acetylene black as the electron conductive material, and PVdF as the binder. The anode current collector was aluminum foil. The electrolyte included 60 mol % of EMI-TFSI and 40 mol % of EMC as a mixture, and a lithium salt, Li-TFSI (Li(CF₃SO₂)₂N, 1.25 M, as the cation source. The separator was a polypropylene porous film.

The cycle test conditions were as follows. After conditioning, the battery was subjected to a 1 C cc-cc charge-discharge for 100 cycles. A second battery (Example 2) was prepared, the only difference to Example 1 being a change in the mixture ratio in the electrolyte to 40 mol % of EMI-TFSI and 60 mol % of EMC.

A reference battery (Reference 1) was prepared in a similar manner to Examples 1 and 2, only the electrolyte did not include an organic additive. The electrolyte was EMI-TFSI.

Table 1 below shows the ion conductivity of electrolyte for the three batteries. The results clearly show a surprisingly great enhancement of the lithium ion conductivity for the two example batteries, having molten salt electrolytes including organic additives, compared with the reference battery.

TABLE 1

| | Example 1 | Example 2 | Reference 1 |
|---|---|---|---|
| Ion conductivity/mScm⁻¹ | 4.58 | 6.84 | 1.52 |

The ion conductivity increases with proportion of organic additive. Lower percentages of organic additive can be used, but the increase in ion conductivity can be expected to be less. However, as the proportion of organic additive increases, at some point the original problems of electrolyte flammability return, The mol % of organic additive within the electrolyte, relative to the molten salt component, can be chosen so that the organic additive is present at a proportion slightly less than that which leads to flammability risk of the electrolyte under normal conditions, but is otherwise as high as possible.

In examples of the present invention, the organic additive is an alkyl carbonate present at a mol % of between 10% and 60%, such as between 40%o and 60%, relative to the molten salt component.

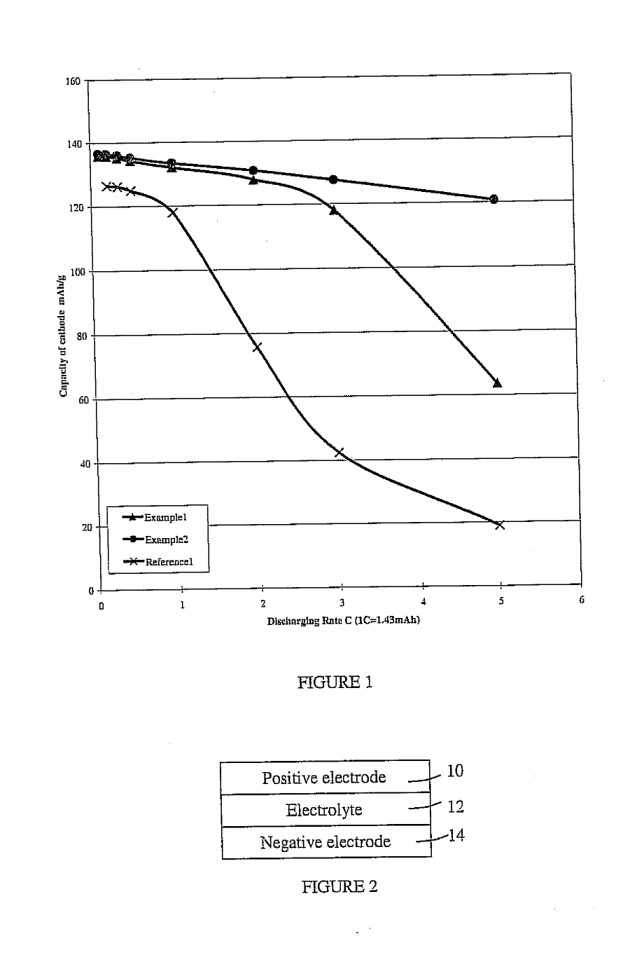

FIG. 1 shows the discharge rate capacity test of the two example rechargeable lithium-ion batteries, compared with the reference battery. The test used a charge-discharge voltage range of 1.5-2.6V. The results showed that the example improved electrolytes were acceptable for use in a lithium-ion battery.

FIG. 2 shows a simplified schematic of a battery comprising a positive electrode 10, electrolyte 12, and negative electrode 14, wherein in an example battery according to the present invention the electrolyte comprises a molten salt, a cation source, and an electrolyte additive chosen so as to increase the cation conductivity of the electrolyte.

Patents or publications mentioned in this specification are herein incorporated by reference to the same extent as if each individual patent or publication was specifically and individually indicated to be incorporated by reference. Examples provided are not intended as limitations on the scope of the invention, which is defined by the claims. Changes therein and other uses will occur to those skilled in the art.

Having described our invention, we claim:

1. A battery, comprising:
a negative electrode;
a positive electrode; and
an electrolyte, having a cation conductivity for transport of a cation through the electrolyte, the electrolyte including:
a molten salt,
a cation source, and
an electrolyte additive, the electrolyte additive being an organic compound chosen to increase the cation conductivity of the electrolyte, wherein the cation is an alkali metal ion, the cation source being an alkali metal salt and wherein the organic compound is present in an amount insufficient for electrolyte flammability under normal operating conditions while increasing the cation conductivity of the electrolyte.

2. The battery of claim 1, wherein the alkali metal ion is a lithium ion is a lithium ion, the battery being a lithium-ion battery.

3. The battery of claim 2, wherein the electrolyte additive comprises an organic carbonate present in a mole percentage of between approximately 10% and 60% relative to the molten salt.

4. The battery of claim 1, wherein the electrolyte additive comprises an organic carbonate present in a mole percentage of between approximately 40% and 60% relative to the molten salt.

5. The battery of claim 1 4, wherein the organic carbonate is an alkyl carbonate.

6-17. (canceled)
